(19) United States
(12) Patent Application Publication
(10) Pub. No.: US 2026/0051822 A1
(43) Pub. Date: Feb. 19, 2026

(54) BIDIRECTIONAL DC/DC CONVERTER AND PULSE WIDTH SIGNAL MODULATION METHOD

(71) Applicant: EVE ENERGY CO., LTD., Huizhou (CN)

(72) Inventors: Bo YANG, Huizhou (CN); Zhen LIU, Huizhou (CN); Wenbing XIAO, Huizhou (CN)

(73) Assignee: EVE ENERGY CO., LTD., Huizhou (CN)

(21) Appl. No.: 19/303,344

(22) Filed: Aug. 18, 2025

(30) Foreign Application Priority Data
Aug. 19, 2024 (CN) 202411139989.4
Aug. 19, 2024 (CN) 202422011892.7
Dec. 2, 2024 (WO) PCT/CN2024/136063

(51) Int. Cl. H02M 3/158; H02M 3/157

(52) U.S. Cl. CPC H02M 3/1586; H02M 3/157

(57) ABSTRACT

This application discloses a bidirectional DC/DC converter and a pulse width signal modulation method. The converter includes a buck-boost module, a control module, and a first timer. The first timer is configured to trigger the control module to output complementary first and second pulse width signals to a first switch and a second switch of the buck-boost module, respectively, in the first counting period. There is a time difference between a rising edge of the first pulse width signal and a falling edge of the second pulse width signal, and a time difference between a falling edge of the first pulse width signal and a rising edge of the second pulse width signal.

### CROSS-REFERENCE TO RELATED APPLICATION

This application claims priority to and the benefit of Chinese Patent Applications NO. 202411139989.4 and NO. 202422011892.7, both filed on Aug. 19, 2024, and International Application No. PCT/CN2024/136063, filed on Dec. 2, 2024. The entire disclosures of the above applications are incorporated herein by reference.

### TECHNICAL FIELD

The present application relates to the field of switching mode power supply technology, and specifically relates to a bidirectional Direct Current/Direct Current (DC/DC) converter and a pulse width signal modulation method.

### BACKGROUND

A bidirectional Direct Current/Direct Current (DC/DC) converter is a power electronic device that can realize bidirectional conversion of electrical energy, which can convert electrical energy from one DC power supply to another DC power supply and can feed back energy from a load to a power supply.

### SUMMARY

In a first aspect, the present disclosure provides a bidirectional DC/DC converter, including:
a first input terminal, a second input terminal, a first output terminal, and a second output terminal;
a bidirectional buck-boost circuit, comprising at least one buck-boost module, wherein each of the at least one buck-boost module comprises a first switch and a second switch, a first terminal of the first switch is electrically connected to the first input terminal, a second terminal of the first switch is electrically connected to the first output terminal, a first terminal of the second switch is electrically connected to the first output terminal, and a second terminal of the second switch is electrically connected to the second input terminal and the second output terminal respectively;
a control module electrically connected to a control terminal of the first switch and a control terminal of the second switch;
a first timer electrically connected to the control module, wherein the first timer is configured to trigger the control module to output a first pulse width signal to the control terminal of the first switch in a preset first counting period, or/and, output a second pulse width signal to the control terminal of the second switch in the preset first counting period.

The first pulse width signal and the second pulse width signal are complementary to each other, a time difference between a rising edge of the first pulse width signal and a falling edge of the second pulse width signal is greater than a first reference time interval, or/and, a time difference between a falling edge of the first pulse width signal and a rising edge of the second pulse width signal is greater than a second reference time interval.

In a second aspect, the present disclosure further provides a pulse width signal modulation method, which is configured in the bidirectional DC/DC converter of the first aspect. The pulse width signal modulation method includes:
generating, in the first counting period, a first triangular carrier by using the first timer; and
starting a modulation of the first triangular carrier at a preset first count value of the first timer to generate the first pulse width signal and the second pulse width signal.

### BRIEF DESCRIPTION OF THE DRAWINGS

FIG. 1 is a structural diagram of a bidirectional DC/DC converter provided by some embodiments of the present disclosure.

FIG. 2 is a schematic flow chart of a pulse width signal modulation method provided by some embodiments of the present disclosure.

FIG. 3 is a timing diagram of the bidirectional DC/DC converter provided by some embodiments of the present disclosure.

FIG. 4 is another structural diagram of the bidirectional DC/DC converter provided by some embodiments of the present disclosure.

FIG. 5 is another timing diagram of the bidirectional DC/DC converter provided by some embodiments of the present disclosure.

FIG. 6 is yet another structural diagram of the bidirectional DC/DC converter provided by some embodiments of the present disclosure.

FIG. 7 is another schematic flow chart of the pulse width signal modulation method provided by some embodiments of the present disclosure.

FIG. 8 is yet another timing diagram of the bidirectional DC/DC converter provided by some embodiments of the present disclosure.

### List of Reference Signs

10, bidirectional buck-boost circuit; 100, buck-boost module; 110, first switch; 120, second switch; 200, control module; 300, first timer; 400, second timer; a1, first count value; a2, second count value; a3, third count value; a4, fourth count value; a5, fifth count value; a6, sixth count value; a7, seventh count value; a8, eighth count value; a9, ninth count value; a10, tenth count value; a11, eleventh count value; a12, twelfth count value; a13, thirteenth count value; t1, first time; t2, second time; t3, third time; t4, fourth time; t5, fifth time; t6, sixth time; t7, seventh time; t8 eighth time; t9, ninth time; t10, tenth time; t11, eleventh time; t12, twelve time; t13, thirteenth time; t14, fourteen time; t15, fifteenth time; t16, sixteenth time; PWM_1, first pulse width signal; PWM_2, second pulse width signal; PWM_3, third pulse width signal; PWM_4, fourth pulse width signal; PWM_5, fifth pulse width signal; PWM_6, sixth pulse width signal; PWM_7, seventh pulse width signal; PWM_8, eighth pulse width signal; Vin+, first input terminal; Vin−, second input terminal; Vout+, first output terminal; and Vout−, second output terminal.

### DETAILED DESCRIPTION

In the related art, when a bidirectional DC/DC converter is configured in a new energy vehicle, an Uninterruptable Power System (UPS), and an Energy Storage System (ESS), the bidirectional DC/DC converter needs an additional set of hardware logic gate circuits to be built or requires program improvements on a control module of the bidirectional DC/DC converter, to ensure seamless and rapid transitions between charging and discharging operations of the bidirectional DC/DC converter.

However, the inclusion of the additional set of hardware logic gate circuits will lead to an increase in the cost of the bidirectional DC/DC converter, and hinder efforts to reduce a volume of the bidirectional DC/DC converter. Furthermore, the program improvements on the control module of the bidirectional DC/DC converter will impose an additional burden on the control module, causing slower processing speeds, reduced reliability, and an inability to meet the requirements of practical applications.

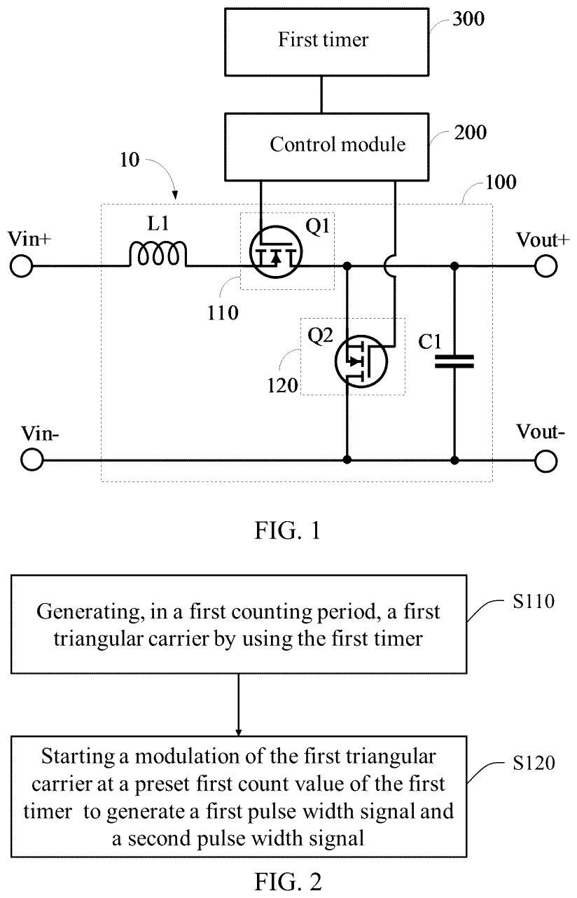

Please refer to FIGS. 1 and 3, FIG. 1 is a structural diagram of a bidirectional DC/DC converter provided by some embodiments of the present disclosure; and FIG. 3 is a timing diagram of the bidirectional DC/DC converter provided by some embodiments of the present disclosure.

As shown in FIGS. 1 and 3, the bidirectional DC/DC converter includes:
a first input terminal Vin+, a second input terminal Vin−, a first output terminal Vout+, and a second output terminal Vout;
a bidirectional buck-boost circuit 10, including at least one buck-boost module 100, wherein each buck-boost module 100 includes a first switch 110 and a second switch 120, a first terminal of the first switch 110 is electrically connected to the first input terminal Vin+, a second terminal of the first switch 110 is electrically connected to the first output terminal Vout+, a first terminal of the second switch 120 is electrically connected to the first output terminal Vout+ of the bidirectional buck-boost circuit 10, and a second terminal of the second switch 120 is electrically connected to both the second input terminal Vin− and the second output terminal Vout− of the bidirectional buck-boost circuit 10;
a control module 200 electrically connected to both a control terminal of the first switch 110 and a control terminal of the second switch 120; and
a first timer 300 electrically connected to the control module 200, wherein the first timer 300 is configured to trigger the control module 200 to output a first pulse width signal PWM_1 to the control terminal of the first switch 110 in a preset first counting period, or/and output a second pulse width signal PWM_2 to the control terminal of the second switch 120 in the preset first counting period.

The first pulse width signal PWM_1 and the second pulse width signal PWM_2 are complementary to each other, and a time difference between a rising edge of the first pulse width signal PWM_1 and a falling edge of the second pulse width signal PWM_2 is greater than a first preset reference time interval; or/and, a time difference between a falling edge of the first pulse width signal PWM_1 and a rising edge of the second pulse width signal PWM_2 is greater than a second preset reference time interval. In cases where multiple first and second pulse width signals are output in the first counting period, the time difference refers to that between a rising/falling edge of one first pulse width signal and a falling/rising edge of one second pulse width signal that is adjacent to the first pulse width signal along the time axis. That is, when determining a time difference between a rising or falling edge of one signal and a rising or falling edge of another signal, which may also be referred to as a time difference between two signals, the two signal are chosen as two adjacent ones along the time axis, and the same applies to other parts of the description.

Specifically, the control module 200 outputs the first pulse width signal PWM_1 to the control terminal of the first switch 110 to control the on/off states of the first switch 110, and at the same time, the control module 200 outputs the second pulse width signal PWM_2 to the control terminal of the second switch 120 to control the on/off states of the second switch 120. The first timer 300 triggers the control module 200 to output at least one of the first pulse width signal PWM_1 and the second pulse width signal PWM_2.

In some embodiments, the first timer 300 triggers the control module 200 to output both the first pulse width signal PWM_1 and the second pulse width signal PWM_2. The control module may be a Digital Signal Processor (DSP).

Please refer to FIG. 1, the first switch 110 may be a Metal Oxide Semiconductor (MOS) tube Q1, and the second switch 120 may be a MOS tube Q2. A gate of the MOS tube Q1 serves as the control terminal of the first switch 110 and is electrically connected to the control module 200, a source of the MOS tube Q1 is electrically connected to the first input terminal Vin+ through an inductor L1, and a drain of the MOS tube Q1 is electrically connected to the first output terminal Vout+. A capacitor C1 is provided between the first output terminal Vout+ and the second output terminal Vout−. A gate of the MOS tube Q2 serves as the control terminal of the second switch 120 and is electrically connected to the control module 200, a source of the MOS tube Q2 is electrically connected to the first output terminal Vout+, and a drain of the MOS tube Q2 is electrically connected to both the second input terminal Vin− and the second output terminal Vout−.

It should be noted that the first input terminal Vin+, the second input terminal Vin−, the first output terminal Vout+, and the second output terminal Vout− mentioned in the present disclosure do not mean that a current flows from the first input terminal Vin+ and/or the second input terminal Vin− to the first output terminal Vout+ and/or the second output terminal Vout−. When the DC/DC converter switches from one mode of a boost mode and a buck mode to the other mode, the current can flow from the first output terminal Vout+ and/or the second output terminal Vout− to the first input terminal Vin+ and/or the second input terminal Vin−.

In some embodiments, as shown in FIG. 2, the present disclosure further provides a pulse width signal modulation method, including operations S110 and S120.

In S110: in a first counting period, the first timer 300 is used to generate a triangular carrier.

In S120: a modulation of the triangular carrier of the first timer to generate the first pulse width signal PWM_1 and the second pulse width signal PWM_2 is started at a preset first count value a1.

Specifically, both the first pulse width signal PWM_1 and the second pulse width signal PWM_2 may be level signals, and the first pulse width signal PWM_1 and the second pulse width signal PWM_2 are complementary to each other.

As shown in FIG. 3, during an operation process of the bidirectional DC/DC converter, when the first pulse width signal PWM_1 is a high level signal and the second pulse width signal PWM_2 is a low level signal, the first switch 110 in the buck-boost module 100 is turned on, and the second switch 120 in the buck-boost module 100 is turned off.

When the first pulse width signal PWM_1 is a low level signal and the second pulse width signal PWM_2 is a high level signal, the first switch 110 in the buck-boost module 100 is turned off, and the second switch 120 in the buck-boost module 100 is turned on. In this way, the buck-boost module 100 can operate in both the boost mode and the buck mode, enabling a bidirectional flow of current.

The bidirectional DC/DC converter provided in the present disclosure includes a first input terminal Vin+, a second input terminal Vin−, a first output terminal Vout+, a second output terminal Vout−, a bidirectional buck-boost circuit 10, a control module 200, and a first timer 300. The bidirectional buck-boost circuit 10 includes at least one buck-boost module 100. Each buck-boost module 100 includes a first switch 110 and a second switch 120. A first terminal of the first switch 110 is electrically connected to the first input terminal Vin+, a second terminal of the first switch 110 and a first terminal of the second switch 120 are electrically connected to the first output terminal Vout+, and a second terminal of the second switch 120 is electrically connected to both the second input terminal Vin− and the second output terminal Vout−. The control module 200 is electrically connected to a control terminal of the first switch 110 and a control terminal of the second switch 120. The first timer 300 is electrically connected to the control module 200, and is configured to trigger the control module 200 to output complementary first pulse width signal PWM_1 and second pulse width signals PWM_2 in a first counting period to control the on/off states of the first switch 110 and of the second switch 120. A time difference between a rising edge of the first pulse width signal PWM_1 and a falling edge of the second pulse width signal PWM_2 is greater than the first preset reference time interval. A time difference between a falling edge of the first pulse width signal PWM_1 and a rising edge of the second pulse width signal PWM_2 is greater than the second preset reference time interval. This not only prevents simultaneous activation of the first switch 110 and the second switch 120, thereby avoiding short circuits. Besides, only a single timer is required in the control module 200 to ensure seamless and rapid transitions between charging and discharging operations of the bidirectional DC/DC converter. This reduces the converter's cost while eliminating the need for program improvements on the control module 200 and enhancing the reliability of the converter.

In some embodiments, as shown in FIG. 3, a count value of the first timer 300 increases progressively in the first half of the first counting period and decreases progressively in the second half of the first counting period, which in turn can cause the first timer 300 to generate a triangular carrier with a first counting period T and an amplitude equal to T/2.

In this embodiment, if a first target count value of the first timer 300 is greater than or equal to the preset first count value a1 and less than or equal to a preset second count value a2, the first pulse width signal PWM_1 is a signal with a preset first level, and the second pulse width signal PWM_2 is a signal with a preset second level. If the first target count value is greater than or equal to a preset third count value a3 and less than or equal to a preset fourth count value a4, the first pulse width signal PWM_1 is a signal with the second level, and the second pulse width signal PWM_2 is a signal with the first level.

The signal with the first level (i.e., the first level signal) and the signal with the second level (i.e., the second level signal) may be a high level signal or a low level signal, the first count value a1 may be 0, and the fourth count value a4 may be a maximum count value of the first timer 300.

In some embodiments, the second count value a2 is smaller than the third count value a3, which in turn realizes that the time difference between the rising edge of the first pulse width signal PWM_1 and the falling edge of the second pulse width signal PWM_2 is greater than the first preset reference time interval, and the time difference between the falling edge of the first pulse width signal PWM_1 and the rising edge of the second pulse width signal PWM_2 is greater than the second preset reference time interval. This forms a dead zone between the first and second pulse width signals PWM_1, PWM_2, thereby avoiding simultaneous conduction of the first switch 110 and the second switch 120, which could cause a short circuit.

In some embodiments, the operation S120 can include the following operations: if the first target count value of the first timer 300 is greater than or equal to the first count value a1 and less than or equal to the preset second count value a2, the first pulse width signal PWM_1 is a high level signal; if the first target count value of the first timer 300 is greater than or equal to the first count value a1 and less than or equal to the preset third count value a3, the second pulse width signal PWM_2 is a low level signal; where the third count value a3 is greater than the second count value a2; if the first target count value of the first timer 300 is greater than the second count value a2 and less than or equal to the preset fourth count value a4, the first pulse width signal PWM_1 is a low level signal; and if the first target count value of the first timer 300 is greater than the third count value a3 and less than or equal to a fourth count value a4, the second pulse width signal PWM_2 is a high level signal.

In this embodiment, the first count value a1 may be a count value at the initial time in the first counting period, the second count value a2 corresponds to the first time t1 and the second time t2 in the first counting period, and the third count value a3 corresponds to the third time t3 and the fourth time t4 in the first counting period. The first time t1 is less than the third time t3, the third time t3 is less than the fourth time t4, and the fourth time t4 is less than the second time t2.

In some embodiments, a count value of the first timer 300 may also decrease progressively in the first half of the first counting period and increase progressively in the second half of the first counting period.

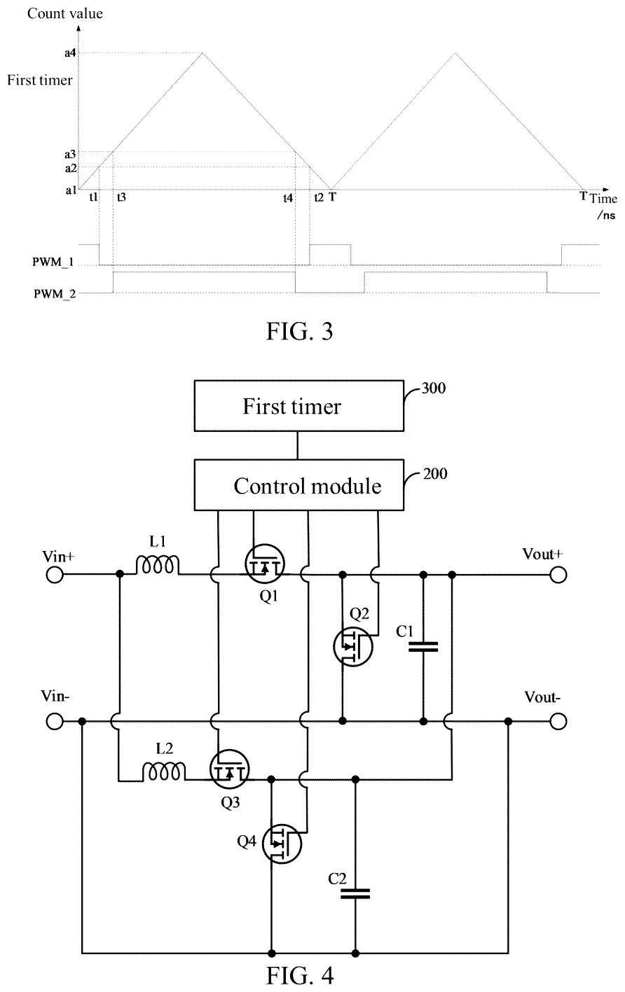

In some embodiments, as shown in FIG. 4, the bidirectional buck-boost circuit 10 includes two buck-boost modules 100 that are connected in parallel. The first timer 300 is configured to trigger the control module 200 to output at least one first control signal in the first counting period, or/and trigger the control module 200 to output at least one second control signal in the first counting period.

Specifically, in order to reduce a ripple of current in the bidirectional DC/DC converter, the present disclosure can further configure two parallel-connected buck-boost modules 100 in the bidirectional buck-boost circuit 10. The two buck-boost modules 100 are respectively a first buck-boost module and a second buck-boost module. Each of the two buck-boost modules 100 is provided with a first switch 110 and a second switch 120. The first switch 110 and the second switch 120 of one of the two buck-boost modules 100 can be MOS tubes Q1 and Q2, while the first switch 110 and the second switch 120 of the other buck-boost module 100 can be MOS tubes Q3 and Q4. A gate of the MOS tube Q3 is electrically connected to the control module 200, a source of the MOS tube Q3 is electrically connected to the first input terminal Vin+ through an inductor L2, and a drain of the MOS tube Q3 is electrically connected to the first output terminal Vout+. A capacitor C2 is provided between the first output terminal Vout+ and the second output terminal Vout−. A gate of the MOS tube Q4 is electrically connected to the control module 200, a source of the MOS tube Q4 is electrically connected to the first output terminal Vout+, and a drain of the MOS tube Q4 is electrically connected to both the second input terminal Vin− and the second output terminal Vout−.

In some embodiments, the first timer 300 is configured to trigger the control module 200 to output four pulse width signals (that is, a first pulse width signal PWM_1, a second pulse width signal PWM_2, a third pulse width signal PWM_3, and a fourth pulse width signal PWM_4) respectively in the first counting period.

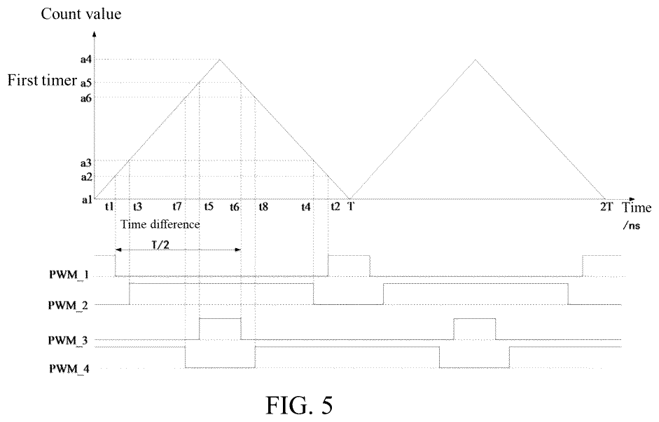

Specifically, as shown in FIG. 5, the first timer 300 is configured to trigger the control module 200 to respectively output the first pulse width signal PWM_1 to the control terminal of the first switch 110 in the first buck-boost module, the third pulse width signal PWM_3 to the control terminal of the first switch 110 in the second buck-boost module, the second pulse width signal PWM_2 to the control terminal of the second switch 120 in the first buck-boost module, and the fourth pulse width signal PWM_4 to the control terminal of the second switch 120 in the second buck-boost module.

As shown in FIG. 5, a time difference between a rising edge of the first pulse width signal PWM_1 and a rising edge of the third pulse width signal PWM_3 is equal to half of the first counting period; a time difference between a falling edge of the first pulse width signal PWM_1 and a falling edge of the third pulse width signal PWM_3 is equal to half of the first counting period; a time difference between a rising edge of the second pulse width signal PWM_2 and a rising edge of the fourth pulse width signal PWM_4 is equal to half of the first counting period; and a time difference between a falling edge of the second pulse width signal PWM_2 and a falling edge of the fourth pulse width signal PWM_4 is equal to half of the first counting period.

In this embodiment, the pulse width signals corresponding to the two first switches 110 in the bidirectional buck-boost circuit 10 may be the first pulse width signal PWM_1 and the third pulse width signal PWM_3, and the pulse width signals corresponding to the two second switches 120 in the bidirectional buck-boost circuit 10 may be the second pulse width signal PWM_2 and the fourth pulse width signal PWM_4. The first pulse width signal PWM_1 and the second pulse width signal PWM_2, generated through the modulation, may be a set of complementary level signals having a dead zone therebetween. The third pulse width signal PWM_3 and the fourth pulse width signal PWM_4, generated through the modulation, may be another set of complementary level signals having a dead zone therebetween.

As shown in FIG. 4, when the third pulse width signal PWM_3 and the fourth pulse width signal PWM_4 are a high level signal and a low level signal respectively, the MOS tube Q3 is turned on and the MOS tube Q4 is turned off. When the third pulse width signal PWM_3 and the fourth pulse width signal PWM_4 are a low level signal and a high level signal respectively, the MOS tube Q3 is turned off and the MOS tube Q4 is turned on. Thus, two inductor current waveforms of the two parallel-connected buck-boost modules 100 can have a 180-degree phase difference, which, after the two waveforms are interleaved, reduces a ripple of a total current of the bidirectional DC/DC converter and improves the performance and reliability of the bidirectional DC/DC converter.

In some embodiments, the present disclosure further provides a pulse width signal modulation method, which includes the following operations: generating a triangular carrier by using the first timer 300 in the first counting period; and starting a modulation of the triangular carrier at the preset first count value a1 to generate the first pulse width signal PWM_1, the second pulse width signal PWM_2, the third pulse width signal PWM_3, and the fourth pulse width signal PWM_4.

Specifically, as shown in FIG. 5, the first pulse width signal PWM_1, the second pulse width signal PWM_2, the third pulse width signal PWM_3, and the fourth pulse width signal PWM_4 can all be level signals, the first pulse width signal PWM_1 and the second pulse width signal PWM_2 are complement each other, and the third pulse width signal PWM_3 and the fourth pulse width signal PWM_4 are modulated to complement each other.

During the operation process of the bidirectional DC/DC converter, when the first pulse width signal PWM_1 is a high level signal and the second pulse width signal PWM_2 is a low level signal, the first switch 110 in the first buck-boost module 100 is turned on and the second switch 120 in the first buck-boost module 100 is turned off.

When the first pulse width signal PWM_1 is a low level signal and the second pulse width signal PWM_2 is a high level signal, the first switch 110 in the first buck-boost module 100 is turned off, and the second switch 120 in the first buck-boost module 100 is turned on.

When the third pulse width signal PWM_3 is a high level signal and the fourth pulse width signal PWM_4 is a low level signal, the first switch 110 in the second buck-boost module 100 is turned on, and the second switch 120 in the second buck-boost module 100 is turned off.

When the third pulse width signal PWM_3 is a low level signal and the fourth pulse width signal PWM_4 is a high level signal, the first switch 110 in the second buck-boost module 100 is turned off, and the second switch 120 in the second buck-boost module 100 is turned on. This may enable the bidirectional DC/DC converter to operate in both the boost mode and the buck mode, thereby achieving bidirectional flow of current.

Meanwhile, there is a 180-degree phase difference between the two sets of pulse width signals, which enables the two inductor current waveforms to have a 180-degree phase difference. After the two waveforms are interleaved, a ripple of a total current can be reduced, thereby improving the performance and reliability of the bidirectional DC/DC converter.

In some embodiments, as shown in FIG. 5, the first timer 300 is further configured to trigger the control module 200 to output the third pulse width signal PWM_3 to the MOS tube Q3 and output the fourth pulse width signal PWM_4 to the MOS tube Q4 in the first counting period.

If the first target count value is greater than or equal to a preset fifth count value a5, the third pulse width signal PWM_3 is the preset first level signal, the fourth pulse width signal PWM_4 is the preset second level signal, and the fifth count value a5 is less than the fourth count value a4.

If the first target count value is greater than or equal to the first count value a1 and is less than or equal to a preset sixth count value a6, the third pulse width signal PWM_3 is the second level signal, and the fourth pulse width signal PWM_4 is the first level signal; and the fifth count value a5 is less than the fourth count value a4, and the sixth count value a6 is less than the fifth count value a5 and greater than the third count value a3.

In some embodiments, the modulation started at the preset first count value a1 to generate the third pulse width signal PWM_3 and the fourth pulse width signal PWM_4 may include: when the first target count value of the first timer 300 is greater than or equal to the first count value a1 and less than the preset fifth count value a5, generating the third pulse width signal PWM_3 with a low level;
when the first target count value of the first timer 300 is greater than or equal to the first count value a1 and is less than the preset sixth count value a6, generating the fourth pulse width signal PWM_4 with a high level, where the fifth count value a5 is greater than the sixth count value a6;
when the first target count value of the first timer 300 is greater than the fifth count value a5 and is less than or equal to the preset fourth count value a4, generating the third pulse width signal PWM_3 with the high level; and
when the first target count value of the first timer 300 is greater than the sixth count value a6 and less than or equal to the fourth count value a4, generating the fourth pulse width signal PWM_4 with the low level.

In this embodiment, the fifth count value a5 corresponds to fifth time t5 and sixth time t6 in the first counting period, and the sixth count value a6 corresponds to seventh time t7 and eighth time t8 in the first counting period. The fifth time t5 is greater than the seventh time t7 and less than the sixth time t6, and the sixth time t6 is less than the eighth time t8.

A time difference between the first time t1 and the sixth time t6 is equal to half of the first counting period, a time difference between the third time t3 and the eighth time t8 is equal to half of the first counting period, a time difference between the seventh time t7 and the fourth time t4 is equal to half of the first counting period, and a time difference between the fifth time t5 and the second time t2 is equal to half of the first counting period.

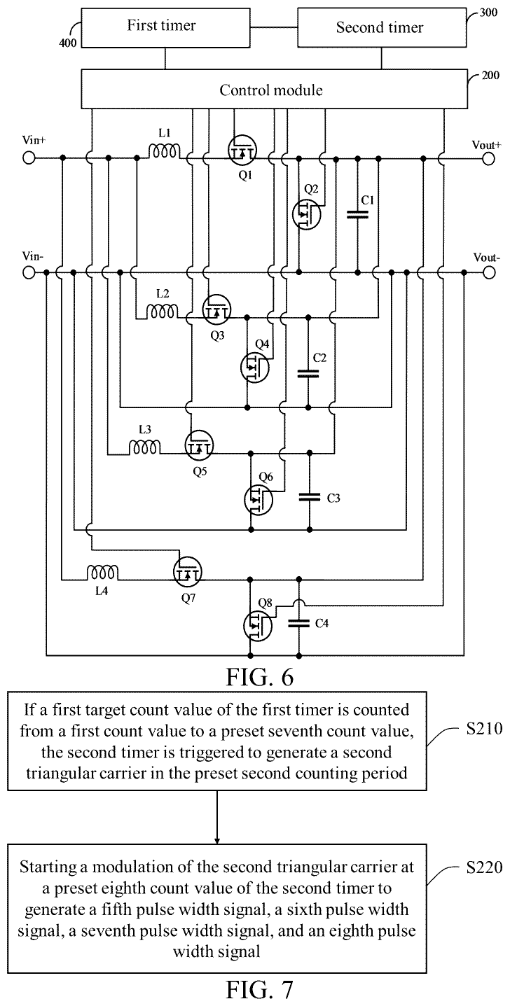

In some embodiments, as shown in FIG. 6, the bidirectional DC/DC converter further includes a second timer 400 electrically connected to the control module 200. The bidirectional buck-boost converter 10 includes four buck-boost modules 100 that are connected in parallel, where the second timer 400 is configured to trigger the control module 200 to output at least one first pulse width signal PWM_1 in a preset second counting period, or/and to trigger the control module 200 to output at least one second pulse width signal PWM_2 in the preset second counting period.

Specifically, in order to further reduce the ripple of current in the bidirectional DC/DC converter, the present disclosure can further configure four parallel-connected buck-boost modules 100 in the bidirectional buck-boost circuit 10. The four buck-boost modules are a first buck-boost module, a second buck-boost module, a third buck-boost module, and a fourth buck-boost module. Each of the four buck-boost modules 100 is provided with a first switch 110 and a second switch 120. The first switch 110 and the second switch 120 of the first buck-boost module 100 may be a MOS tube Q1 and a MOS tube Q2, the first switch 110 and the second switch 120 of the second buck-boost module 100 may be a MOS tube Q3 and a MOS tube Q4, the first switch 110 and the second switch 120 of the third buck-boost module 100 may be a MOS tube Q5 and a MOS tube Q6, and the first switch 110 and the second switch 120 of the fourth buck-boost module 100 may be a MOS tube Q7 and a MOS tube Q8.

A gate of the MOS transistor Q5 is electrically connected to the control module 200, a source of the MOS transistor Q5 is electrically connected to the first input terminal Vin+ through an inductor L3, and a drain of the MOS transistor Q5 is electrically connected to the first output terminal Vout+. A capacitor C3 is provided between the first output terminal Vout+ and the second output terminal Vout−. A gate of the MOS transistor Q6 is electrically connected to the control module 200, a source of the MOS transistor Q6 is electrically connected to the first output terminal Vout+, and a drain of the MOS transistor Q6 is electrically connected to both the second input terminal Vin− and the second output terminal Vout−.

A gate of the MOS transistor Q7 is electrically connected to the control module 200, a source of the MOS transistor Q7 is electrically connected to the first input terminal Vin+ through an inductor L4, and a drain of the MOS transistor Q7 is electrically connected to the first output terminal Vout+. A capacitor C4 is provided between the first output terminal Vout+ and the second output terminal Vout−. A gate of MOS transistor Q8 is electrically connected to the control module 200, a source of the MOS transistor Q8 is electrically connected to the first output terminal Vout+, and a drain of the MOS transistor Q8 is electrically connected to both the second input terminal Vin− and the second output terminal Vout−.

In some embodiments, as shown in FIG. 6, the second timer 400 is electrically connected to the first timer 300, and the first timer 300 is further configured to trigger the second timer 400 to count in the second counting period.

In this embodiment, the first timer 300 may be a master timer in the bidirectional DC/DC converter, and the second timer 400 may be a slave timer in the bidirectional DC/DC converter. After counting for a period of time, the first timer 300 may trigger the second timer 400 to start counting in its second counting period to trigger the control module to output two sets of complementary pulse width signals again (one set is a fifth pulse width signal PWM_5 and a sixth pulse width signal PWM_6 which are a set of complementary level signals having a dead zone therebetween, and the other one set is a seventh pulse width signal PWM_7 and an eighth pulse width signal PWM_8 which are a set of complementary level signals having a dead zone therebetween), so that the control module can output four sets of pulse width signals.

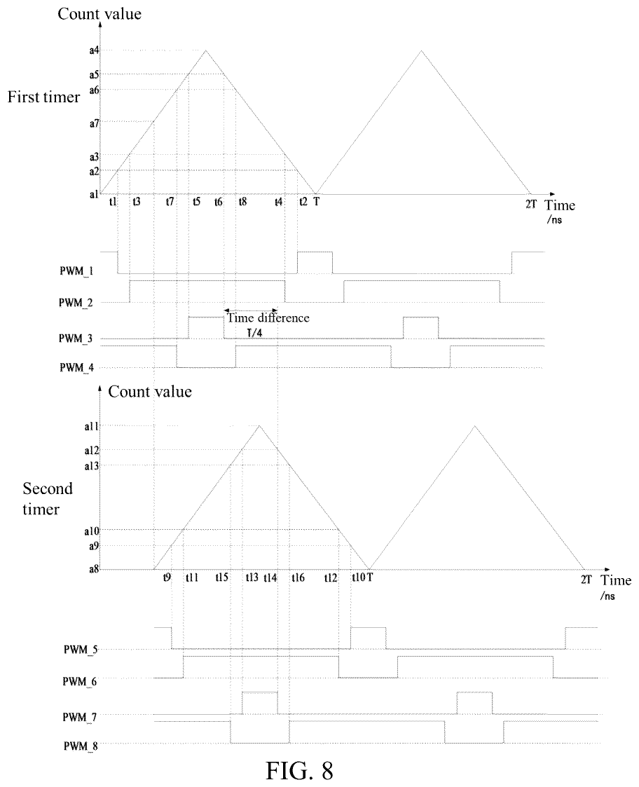

As shown in FIG. 8, the four sets of pulse width signals are: the first pulse width signal PWM_1 and the second pulse width signal PWM_2; the third pulse width signals PWM_3 and the fourth pulse width signal PWM_4; the fifth pulse width signals PWM_5 and the sixth pulse width signal PWM_6; and the seventh pulse width signals PWM_7 and the eighth pulse width signals PWM_8.

In some embodiments, as shown in FIG. 7, the present disclosure further provides a pulse width signal modulation method, including operations S210 and S220.

In S210: if a first target count value of the first timer 300 is counted from a first count value a1 to a preset seventh count value a7, the second timer is triggered to generate a triangular carrier in the preset second counting period.

In S220: a modulation of the triangular carrier is started at a preset eighth count value a8 to generate the fifth pulse width signal PWM_5, the sixth pulse width signal PWM_6, the seventh pulse width signal PWM_7, and the eighth pulse width signal PWM_8.

Specifically, as shown in FIG. 8, the first pulse width signal PWM_1, the second pulse width signal PWM_2, the third pulse width signal PWM_3, the fourth pulse width signal PWM_4, the fifth pulse width signal PWM_5, the sixth pulse width signal PWM_6, the seventh pulse width signal PWM_7, and the eighth pulse width signal PWM_8 may all be level signals. The first pulse width signal PWM_1 and the second pulse width signal PWM_2 are complement each other, the third pulse width signal PWM_3 and the fourth pulse width signal PWM_4 are complement each other, the fifth pulse width signal PWM_5 and the sixth pulse width signal PWM_6 are complement each other, and the seventh pulse width signal PWM_7 and the eighth pulse width signal PWM_8 to complement each other.

During the operation process of the bidirectional DC/DC converter, when the first pulse width signal PWM_1 is a high level signal and the second pulse width signal PWM_2 is a low level signal, the first switch 110 in the first buck-boost module 100 is turned on, and the second switch 120 in the first buck-boost module 100 is turned off.

When the first pulse width signal PWM_1 is a low level signal and the second pulse width signal PWM_2 is a high level signal, the first switch 110 in the first buck-boost module 100 is turned off and the second switch 120 in the first buck-boost module 100 is turned on.

When the third pulse width signal PWM_3 is a high level signal and the fourth pulse width signal PWM_4 is a low level signal, the first switch 110 in the second buck-boost module 100 is turned on and the second switch 120 in the second buck-boost module 100 is turned off.

When the third pulse width signal PWM_3 is a low level signal and the fourth pulse width signal PWM_4 is a high level signal, the first switch 110 in the second buck-boost module 100 is turned off and the second switch 120 in the second buck-boost module 100 is turned on.

When the fifth pulse width signal PWM_5 is a high level signal and the sixth pulse width signal PWM_6 is a low level signal, the first switch 110 in the third buck-boost module 100 is turned on and the second switch 120 in the third buck-boost module 100 is turned off.

When the fifth pulse width signal PWM_5 is a low level signal and the sixth pulse width signal PWM_6 is a high level signal, the first switch 110 in the third buck-boost module 100 is turned off and the second switch 120 in the third buck-boost module 100 is turned on.

When the seventh pulse width signal PWM_7 is a high level signal and the eighth pulse width signal PWM_8 is a low level signal, the first switch 110 in the fourth buck-boost module 100 is turned on and the second switch 120 in the fourth buck-boost module 100 is turned off.

When the seventh pulse width signal PWM_7 is a low level signal and the eighth pulse width signal PWM_8 is a high level signal, the first switch 110 in the fourth buck-boost module 100 is turned off and the second switch 120 in the fourth buck-boost module 100 is turned on. This can enable the bidirectional DC/DC converter to operate in both the boost mode and the buck mode, thereby achieving bidirectional flow of current.

In addition, there is a 90-degree phase difference between each of the following pairs: the first pulse width signal PWM_1 and the fifth pulse width signal PWM_5, the second pulse width signal PWM_2 and the sixth pulse width signal PWM_6, the third pulse width signal PWM_3 and the seventh pulse width signal PWM_7, and the fourth pulse width signal PWM_4 and the eighth pulse width signal PWM_8. This can realize a cyclic phase relationship among the corresponding four inductors'current waveforms, each having a 90-degree phase difference with the next one in the sequence. After the four waveforms interleaved, a ripple of a total current can be reduced, thereby improving the performance and reliability of the bidirectional DC/DC converter.

In some embodiments, the first timer 300 is configured to trigger the control module 200 to output the first pulse width signal PWM_1, the second pulse width signal PWM_2, the third pulse width signal PWM_3, and the fourth pulse width signal PWM_4 in the first counting period; and the second timer 400 is configured to trigger the control module 200 to output the fifth pulse width signal PWM_5, the sixth pulse width signal PWM_6, the seventh pulse width signal PWM_7, and the eighth pulse width signal PWM_8 in the second counting period.

In this embodiment, the first counting period is equal to the second counting period. If the first target count value reaches the preset seventh count value a7, the second timer 400 starts counting in the second counting period. A time difference between the seventh count value a7 and the fourth count value a4 is equal to one quarter of the first counting period.

If a second target count value of the second timer 400 is greater than or equal to the preset eighth count value a8 and less than or equal to a preset ninth count value a9, the fifth pulse width signal PWM_5 is a first level signal, and the sixth pulse width signal PWM_6 is a second level signal.

If the second target count value is greater than or equal to a preset tenth count value a10 and less than or equal to a preset eleventh count value a11, the fifth pulse width signal PWM_5 is the second level signal and the sixth pulse width signal PWM_6 is the first level signal.

If the second target count value is greater than or equal to a preset twelfth count value a12, the seventh pulse width signal PWM_7 is the first level signal and the eighth pulse width signal PWM_8 is the second level signal, where the twelfth count value a12 is less than the eleventh count value a11.

If the second target count value is greater than or equal to the eighth count value a8 and is less than or equal to a preset thirteenth count value a13, the seventh pulse width signal PWM_7 is the second level signal and the eighth pulse width signal PWM_8 is the first level signal.

The ninth count value a9 is smaller than the tenth count value a10, the twelfth count value a12 is smaller than the eleventh count value a11, the thirteenth count value a13 is smaller than the twelfth count value a12 and greater than the tenth count value a10, and a time difference between the first count value a1 and the seventh count value a7 may be a quarter of the first counting period or of the second counting period.

Meanwhile, the ninth count value a9 corresponds to ninth time t9 and tenth time t10 in the second counting period. The tenth count value a10 corresponds to eleventh time t11 and twelfth time t12 in the second counting period. The ninth time t9 is less than the eleventh time t11, the eleventh time t11 is less than the twelfth time t12, and the twelfth time t12 is less than the tenth time t10. The twelfth count value a12 corresponds to thirteenth time t13 and fourteenth time t14 in the second counting period. The thirteenth count value a13 corresponds to fifteenth time t15 and sixteenth time t16 in the second counting period. The thirteenth time t13 is greater than the fifteenth time t15 and less than the fourteenth time t14, and the fourteenth time t14 is less than the sixteenth time t16.

In some embodiments, as shown in FIG. 8, a time difference between the rising edge of the first pulse width signal PWM_1 and a rising edge of the fifth pulse width signal PWM_5 is equal to one quarter of the first (or second) counting period; a time difference between a falling edge of the first pulse width signal PWM_1 and a falling edge of the fifth pulse width signal PWM_5 is equal to one quarter of the first (or second) counting period; a time difference between a rising edge of the second pulse width signal PWM_2 and a rising edge of the sixth pulse width signal PWM_6 is equal to one quarter of the first (or second) counting period; a time difference between a falling edge of the second pulse width signal PWM_2 and a falling edge of the sixth pulse width signal PWM_6 is equal to one quarter of the first (or second) counting period; a time difference between a rising edge of the third pulse width signal PWM_3 and a rising edge of the seventh pulse width signal PWM_7 is equal to one quarter of the first (or second) counting period; a time difference between a falling edge of the third pulse width signal PWM_3 and a falling edge of the seventh pulse width signal PWM_7 is equal to one quarter of the first (or second) counting period; a time difference between a rising edge of the fourth pulse width signal PWM_4 and a rising edge of the eighth pulse width signal PWM_8 is equal to one quarter of the first (or second) counting period; and a time difference between a falling edge of the fourth pulse width signal PWM_4 and a falling edge of the eighth pulse width signal PWM_8 is equal to one quarter of the first (or second) counting period.

In this embodiment, when the first target count value of the first timer 300 is less than or equal to the second count value a2, the first pulse width signal PWM_1 is a high level signal, and the second pulse width signal PWM_2 is a low level signal.

When the first target count value of the first timer 300 is greater than or equal to the second count value a2, the first pulse width signal PWM_1 is a low level signal, and the second pulse width signal PWM_2 is modulated to a high level signal, thereby outputting a set of complementary PWM waveforms.

When the first target count value of the first timer 300 is less than or equal to the fifth count value a5, the third pulse width signal PWM_3 is a high level signal and the fourth pulse width signal PWM_4 is a low level signal.

When the first target count value of the first timer 300 is greater than or equal to the fifth count value a5, the third pulse width signal PWM_3 is a low level signal, and the fourth pulse width signal PWM_4 is a high level signal, thereby outputting a set of complementary PWM waveforms too.

A sum of the second count value a2 and the fifth count value a5 is equal to half of the first counting period, so the time difference between the third pulse width signal PWM_3 and the first pulse width signal PWM_1 may be T/2, which is 180-degree phase difference if converted into a phase difference.

When the first target count value of the first timer 300 is equal to the seventh count value a7, since a time difference between the first count value a1 and the seventh count value a7 can be a quarter of the first counting period or of the second counting period, the first timer 300 can trigger the second timer 400 to start counting.

When the second target count value of the second timer 400 is less than or equal to the ninth count value a9, the fifth pulse width signal PWM_5 is a high level signal and the sixth pulse width signal PWM_6 is a low level signal.

When the second target count value of the second timer 400 is greater than or equal to the ninth count value a9, the fifth pulse width signal PWM_5 is a low level signal, and the sixth pulse width signal PWM_6 is a high level signal, thereby outputting a set of complementary PWM waveforms. Since a time difference between the first count value a1 and the seventh count value a7 can be a quarter of the first counting period or of the second counting period, the time difference between the fifth pulse width signal PWM_5 and the first pulse width signal PWM_1 is T/4, which is 90-degree phase difference if converted into a phase difference.

When the second target count value of the second timer 400 is less than or equal to the twelfth count value a12, the seventh pulse width signal PWM_7 is a low level signal, and the eighth pulse width signal PWM_8 is a high level signal. When a real-time count is greater than or equal to the twelfth count value a12, the seventh pulse width signal PWM_7 is a high level signal, and the eighth pulse width signal PWM_8 is a low level signal, thereby outputting a set of complementary PWM waveforms.

The time difference between the seventh pulse width signal PWM_7 and the third pulse width signal PWM_3 is half of the second counting period, which is 180-degree phase difference if converted into a phase difference.

In conclusion, there is a 90-degree phase difference between the set of the first pulse width signal PWM_1 and the second pulse width signal PWM_2 and the set of the fifth pulse width signal PWM_5 and the sixth pulse width signal PWM_6. There is a 90-degree phase difference between the set of the third pulse width signal PWM_3 and the fourth pulse width signal PWM_4 and the set of the seventh pulse width signal PWM_7 and the eighth pulse width signal PWM_8. Furthermore, there is a 180-degree phase difference between the set of the first pulse width signal PWM_1 and the second pulse width signal PWM_2 and the set of the third pulse width signal PWM_3 and the fourth pulse width signal PWM_4, and between the set of the fifth pulse width signal PWM_5 and the third pulse width signal PWM_6 and the set of the seventh pulse width signal PWM_7 and the eighth pulse width signal PWM_8. Thus, the four sets of pulse width signals can form phase interleaved complementary PWM waveforms with a 90-degree phase shift.

In some embodiments, a count value of the second timer 400 increases progressively in the first half of the second counting period and decreases progressively in the second half of the second counting period, which in turn can cause the second timer 400 to generate a triangular carrier with the second counting period equal to the first counting period T and an amplitude equal to T/2.

In this embodiment, a count value of the first timer 300 increases progressively in the first half of the first counting period and decreases progressively in the second half of the first counting period, a count value of the second timer 400 increases progressively in the first half of the second counting period, and decreases progressively in the second half of the second counting period, so that both the first timer 300 and the second timer 400 can generate a triangular carrier with the first counting period T and the amplitude T/2.

In some embodiments, the modulation to generate the fifth pulse width signal PWM_5, the sixth pulse width signal PWM_6, the seventh pulse width signal PWM_7, and the eighth pulse width signal PWM_8 are started at the seventh count value a7, and the modulation includes the following operations: if the second target count value of the second timer 400 is greater than or equal to the eighth count value a8 and less than or equal to the preset ninth count value a9, generating the fifth pulse width signal PWM_5 with a high level.

If the second target count value of the second timer 400 is greater than or equal to the eighth count value a8 and less than or equal to the preset tenth count value a10, the sixth pulse width signal PWM_6 is a low level signal; where the tenth count value a10 is greater than the ninth count value a9.

If the second target count value of the second timer 400 is greater than the ninth count value a9 and is less than or equal to the preset eleventh count value a11, the fifth pulse width signal PWM_5 is a low level signal.

If the second target count value of the second timer 400 is greater than the tenth count value a10 and is less than or equal to the eleventh count value a11, the sixth pulse width signal PWM_6 is a high level signal.

If the second target count value of the second timer 400 is greater than or equal to the eighth count value a8 and less than the twelfth count value a12, the seventh pulse width signal PWM_7 is a low level signal.

If the second target count value of the second timer 400 is greater than or equal to the eighth count value a8 and less than the preset thirteenth count value a13, the eighth pulse width signal PWM_8 is a high level signal. The twelfth count value a12 is greater than the thirteenth count value a13.

If the second target count value of the second timer 400 is greater than the twelfth count value a12 and less than or equal to the eleventh count value a11, the seventh pulse width signal PWM_7 is a high level signal.

If the second target count value of the second timer 400 is greater than the thirteenth count value a13 and is less than or equal to the eleventh count value a11, the eighth pulse width signal PWM_8 will be a low level signal.

In some embodiments, a1 is equal to a8, a2 is equal to a9 , a3 is equal to a10, a4 is equal to a11, a5 is equal to a12, and a6 is equal to a13.

Specifically, the modulation process of the four sets of pulse width signals generated by the present disclosure can be as follows.

Starting from time 0, the first timer 300 generates a triangular carrier. By adopting a central symmetric counting method, the first timer 300 counts 1 per 1 nanosecond (ns) to progressively increase its count value to T/2. That is, the count value of the first timer 300 first increments from 0 to T/2 and then decrements from T/2 to 0. Therefore, a quarter period of the triangular carrier wave is T/4, a half period is T/2, and a full period is T (ns). When the first target count value of the first timer 300 is less than the second count value a2, the first pulse width signal PWM_1 is a high level signal, and the second pulse width signal PWM_2 is a low level signal.

When the first target count value of the first timer 300 is greater than or equal to the second count value a2, the first pulse width signal PWM_1 is a low level signal, and the second pulse width signal PWM_2 is a high level signal.

A sum of the second count value a2 and the fifth count value a5 is equal to half of the first counting period. Therefore, the time difference between the third pulse width signal PWM_3 and the first pulse width signal PWM_1 can be T/2, which is 180-degree phase difference if converted into a phase difference.

When the first target count value of the first timer 300 is equal to the seventh count value a7, since the seventh count value a7 may be one quarter of the first counting period or of the second counting period, the first timer 300 may trigger the second timer 400 to start counting.

When the second target count value of the second timer 400 is less than the ninth count value a9, the fifth pulse width signal PWM_5 is a high level signal and the sixth pulse width signal PWM_6 is a low level signal.

When the second target count value of the second timer 400 is greater than or equal to the ninth count value a9, the fifth pulse width signal PWM_5 is a low level signal, and the sixth pulse width signal PWM_6 is a high level signal.

When the first target count value of the first timer 300 is less than the fifth count value a5, the third pulse width signal PWM_3 is a high level signal, and the fourth pulse width signal PWM_4 is a low level signal.

When the first target count value of the first timer 300 is greater than or equal to the fifth count value a5, the third pulse width signal PWM_3 is a low level signal and the fourth pulse width signal PWM_4 is a high level signal.

When the second target count value of the second timer 400 is less than the twelfth count value a12, the seventh pulse width signal PWM_7 is a high level signal and the eighth pulse width signal PWM_8 is a low level signal.

When the second target count value of the second timer 400 is greater than or equal to the twelfth count value a12, the seventh pulse width signal PWM_7 is a low level signal, and the eighth pulse width signal PWM_8 is a high level signal.

In some embodiments, the second timer 400 counts down (i.e., the count value progressively decreases) in the first half of the second counting period and counts up (i.e., the count value progressively increases) in the second half of the second counting period.

What is claimed is:

1. A bidirectional DC/DC converter, comprising:
a first input terminal, a second input terminal, a first output terminal, and a second output terminal;
a bidirectional buck-boost circuit, comprising at least one buck-boost module, wherein each of the at least one buck-boost module comprises a first switch and a second switch, a first terminal of the first switch is electrically connected to the first input terminal, a second terminal of the first switch is electrically connected to the first output terminal, a first terminal of the second switch is electrically connected to the first output terminal, and a second terminal of the second switch is electrically connected to the second input terminal and the second output terminal respectively;
a control module electrically connected to a control terminal of the first switch and a control terminal of the second switch; and
a first timer electrically connected to the control module, wherein the first timer is configured to trigger the control module to output a first pulse width signal to the control terminal of the first switch in a preset first counting period, or/and, output a second pulse width signal to the control terminal of the second switch in the preset first counting period;
wherein the first pulse width signal and the second pulse width signal are complementary to each other, a time difference between a rising edge of the first pulse width signal and a falling edge of the second pulse width signal is greater than a first preset reference time interval, or/and, a time difference between a falling edge of the first pulse width signal and a rising edge of the second pulse width signal is greater than a second preset reference time interval.

2. The bidirectional DC/DC converter according to claim 1, wherein the at least one buck-boost module comprises two buck-boost modules that are connected in parallel, and the two buck-boost modules are respectively a first buck-boost module and a second buck-boost module;
wherein the first timer is configured to trigger the control module to output the first pulse width signal to the control terminal of the first switch in the first buck-boost module and a third pulse width signal to the control terminal of the first switch in the second buck-boost module in the first counting period, or/and to trigger the control module to output the second pulse width signal to the control terminal of the second switch in the first buck-boost module and a fourth pulse width signal to the control terminal of the second switch in the second buck-boost module in the first counting period.

3. The bidirectional DC/DC converter according to claim 2, wherein a time difference between the rising edge of the first pulse width signal and a rising edge of the third pulse width signal is equal to half of the first counting period, or/and a time difference between the falling edge of the first pulse width signal and a falling edge of the third pulse width signal is equal to half of the first counting period; or/and,
a time difference between the rising edge of the second pulse width signal and a rising edge of the fourth pulse width signal is equal to half of the first counting period, or/and a time difference between the falling edge of the second pulse width signal and a falling edge of the fourth pulse width signal is equal to half of the first counting period.

4. The bidirectional DC/DC converter according to claim 1, wherein a count value of the first timer increases progressively in a first half of the first counting period and decreases progressively in a second half of the first counting period; or
the count value of the first timer decreases progressively in the first half of the first counting period and increases progressively in the second half of the first counting period.

5. The bidirectional DC/DC converter according to claim 1, further comprising a second timer electrically connected to the control module, and the at least one buck-boost module comprises four buck-boost modules that are connected in parallel, and the four buck-boost modules are respectively a first buck-boost module, a second buck-boost module, a third buck-boost module, and a fourth buck-boost module;
wherein the second timer is configured to trigger the control module to output a fifth pulse width signal to the first switch in the third buck-boost module and a seventh pulse width signal to the first switch in the fourth buck-boost module in a preset second counting period, or/and to trigger the control module to output a sixth pulse width signal to the second switch in the third buck-boost module and an eighth pulse width signal to the second switch in the fourth buck-boost module.

6. The bidirectional DC/DC converter according to claim 5, wherein the second timer is electrically connected to the first timer, and the first timer is further configured to trigger the second timer to count.

7. The bidirectional DC/DC converter according to claim 5, wherein the first counting period is equal to the second counting period.

8. The bidirectional DC/DC converter according to claim 7, wherein a time difference between the rising edge of the first pulse width signal and a rising edge of the fifth pulse width signal is equal to one quarter of the first counting period, or/and a time difference between the falling edge of the first pulse width signal and a falling edge of the fifth pulse width signal is equal to one quarter of the first counting period; or/and
a time difference between the rising edge of the second pulse width signal and a rising edge of the sixth pulse width signal is equal to one quarter of the second counting period, or/ and a time difference between the falling edge of the second pulse width signal and a falling edge of the sixth pulse width signal is equal to one quarter of the second counting period; or/and
a time difference between rising edges of the third pulse width signal and the seventh pulse width signal is equal to one quarter of the first counting period, or/and a time difference between falling edges of the third pulse width signal and the seventh pulse width signal is equal to one quarter of the first counting period; or/and
a time difference between rising edges of the fourth pulse width signal and the eighth pulse width signal is equal to one quarter of the second counting period, or/and a time difference between falling edges of the fourth pulse width signal and the eighth pulse width signal is equal to one quarter of the second counting period.

9. The bidirectional DC/DC converter according to claim 5, wherein a count value of the second timer increases progressively in a first half of the second counting period and decreases progressively in a second half of the second counting period; or
the count value of the second timer decreases progressively in the first half of the second counting period and increases progressively in the second half of the second counting period.

10. The bidirectional DC/DC converter according to claim 1, wherein at least one of the first switch and the second switch is a Metal Oxide Semiconductor transistor; or/and
the control module is a digital signal processor.

11. A pulse width signal modulation method applied to a bidirectional DC/DC converter, wherein the bidirectional DC/DC converter comprises:
a first input terminal, a second input terminal, a first output terminal, and a second output terminal;
a bidirectional buck-boost circuit, comprising at least one buck-boost module, wherein each of the at least one buck-boost module comprises a first switch and a second switch, a first terminal of the first switch is electrically connected to the first input terminal, a second terminal of the first switch is electrically connected to the first output terminal, a first terminal of the second switch is electrically connected to the first output terminal, and a second terminal of the second switch is electrically connected to the second input terminal and the second output terminal respectively;
a control module electrically connected to a control terminal of the first switch and a control terminal of the second switch; and
a first timer electrically connected to the control module, wherein the first timer is configured to trigger the control module to output a first pulse width signal to the control terminal of the first switch in a preset first counting period, or/and, output a second pulse width signal to the control terminal of the second switch in the preset first counting period;
wherein the first pulse width signal and the second pulse width signal are complementary to each other, a time difference between a rising edge of the first pulse width signal and a falling edge of the second pulse width signal is greater than a first reference time interval, or/and, a time difference between a falling edge of the first pulse width signal and a rising edge of the second pulse width signal is greater than a second reference time interval;
wherein the method comprises:
generating, in the first counting period, a first triangular carrier by using the first timer; and
starting a modulation of the first triangular carrier at a preset first count value of the first timer to generate the first pulse width signal and the second pulse width signal.

12. The pulse width signal modulation method according to claim 11, wherein the starting of the modulation of the first triangular carrier at the preset first count value of the first timer to generate the first pulse width signal and the second pulse width signal comprises:
when a first target count value of the first timer is greater than or equal to the first count value and less than or equal to a preset second count value, generating the first pulse width signal with a high level, wherein the second count value is greater than the first count value;
when the first target count value of the first timer is greater than or equal to the first count value and less than or equal to a preset third count value, generating the second pulse width signal with a low level, wherein the third count value is greater than the second count value;
when the first target count value of the first timer is greater than the second count value and less than or equal to a preset fourth count value, generating the first pulse width signal to with the low level, wherein the fourth count value is greater than the third count value; and
when the first target count value of the first timer is greater than the third count value and less than or equal to the fourth count value, generating the second pulse width signal with the high level.

13. The pulse width signal modulation method according to claim 11, wherein the at least one buck-boost module comprises two buck-boost module that are connected in parallel, and the two buck-boost modules are respectively a first buck-boost module and a second buck-boost module;
wherein the first timer is configured to trigger the control module to output the first pulse width signal to the control terminal of the first switch in the first buck-boost module and a third pulse width signal to the control terminal of the first switch in the second buck-boost module in the first counting period, or/and to trigger the control module to output the second pulse width signal to the control terminal of the second switch in the first buck-boost module and a fourth pulse width signal to the control terminal of the second switch in the second buck-boost module in the first counting period.

14. The pulse width signal modulation method according to claim 13, wherein the method further comprises:
starting a modulation of the first triangular carrier at the first count value to generate the third pulse width signal and the fourth pulse width signal.

15. The pulse width signal modulation method according to claim 14, wherein the starting of the modulation of the first triangular carrier at the first count value to generate the third pulse width signal and the fourth pulse width signal comprises:
when the first target count value of the first timer is greater than or equal to the first count value and less than a preset fifth count value, generating the third pulse width signal with a low level;
when the first target count value of the first timer is greater than or equal to the first count value and less than a preset sixth count value, generating the fourth pulse width signal with a high level, wherein the sixth count value is greater than the fifth count value;
when the first target count value of the first timer is greater than the fifth count value and less than or equal to the preset fourth count value, generating the third pulse width signal with the high level; and
when the first target count value of the first timer is greater than the sixth count value and less than or equal to the fourth count value, generating the fourth pulse width signal with the low level.

16. The pulse width signal modulation method according to claims 11, wherein the bidirectional DC/DC converter further comprises a second timer electrically connected to the control module, the at least one buck-boost module comprises four buck-boost modules that are connected in parallel, and the four buck-boost modules are respectively a first buck-boost module, a second buck-boost module, a third buck-boost module, and a fourth buck-boost module;
wherein the second timer is configured to trigger the control module to output a fifth pulse width signal to the first switch in the third buck-boost module and a seventh pulse width signal to the first switch in the fourth buck-boost module in a preset second counting period, or/and
to trigger the control module to output a sixth pulse width signal to the second switch in the third buck-boost module and an eighth pulse width signal to the second switch in the fourth buck-boost module.

17. The pulse width signal modulation method according to claims 16, wherein the method further comprises:
when the first target count value of the first timer is counted from the first count value to a preset seventh count value, triggering the second timer to generate a second triangular carrier in a preset second counting period, the second triangular carrier being identical to the first triangular carrier; and
starting a modulation of the second triangular carrier at a preset eighth count value of the second timer to generate the fifth pulse width signal, the sixth pulse width signal, the seventh pulse width signal, and the eighth pulse width signal.

18. The pulse width signal modulation method according to claim 17, wherein the starting of the modulation of the second triangular carrier at the preset eighth count value of the second timer to generate the fifth pulse width signal, the sixth pulse width signal, the seventh pulse width signal, and the eighth pulse width signal comprises:
when the second target count value of the second timer is greater than or equal to the eighth count value and less than or equal to a preset ninth count value, generating the fifth pulse width signal with a high level;
when the second target count value of the second timer is greater than or equal to the eighth count value and less than or equal to a preset tenth count value, generating the sixth pulse width signal with a low level, wherein the tenth count value is greater than the ninth count value;
when the second target count value of the second timer is greater than the ninth count value and less than or equal to a preset eleventh count value, generating the fifth pulse width signal with the low level;
when the second target count value of the second timer is greater than the tenth count value and less than or equal to an eleventh count value, generating the sixth pulse width signal with the high level;
when the second target count value of the second timer is greater than or equal to the eighth count value and less than or equal to a twelfth count value, generating the seventh pulse width signal with the low level;
when the second target count value of the second timer is greater than or equal to the eighth count value and less than or equal to a thirteenth count value, generating the eighth pulse width signal with the high level, wherein the twelfth count value is greater than the thirteenth count value;
when the second target count value of the second timer is greater than the twelfth count value and less than or equal to the eleventh count value, generating the seventh pulse width signal with the high level; and
when the second target count value of the second timer is greater than the thirteenth count value and less than or equal to the eleventh count value, generating the eighth pulse width signal with the low level.

19. The pulse width signal modulation method according to claim 13, a time difference between the rising edge of the first pulse width signal and a rising edge of the third pulse width signal is equal to half of the first counting period, or/and a time difference between the falling edge of the first pulse width signal and a falling edge of the third pulse width signal is equal to half of the first counting period; or/and,
a time difference between the rising edge of the second pulse width signal and a rising edge of the fourth pulse width signal is equal to half of the first counting period, or/and a time difference between the falling edge of the second pulse width signal and a falling edge of the fourth pulse width signal is equal to half of the first counting period.

20. The pulse width signal modulation method according to claim 14, wherein a time difference between the rising edge of the first pulse width signal and a rising edge of the fifth pulse width signal is equal to one quarter of the first counting period, or/and a time difference between the falling edge of the first pulse width signal and a falling edge of the fifth pulse width signal is equal to one quarter of the first counting period; or/and
a time difference between the rising edge of the second pulse width signal and a rising edge of the sixth pulse width signal is equal to one quarter of the second counting period, or/ and a time difference between the falling edge of the second pulse width signal and a falling edge of the sixth pulse width signal is equal to one quarter of the second counting period; or/and
a time difference between rising edges of the third pulse width signal and the seventh pulse width signal is equal to one quarter of the first counting period, or/and a time difference between falling edges of the third pulse width signal and the seventh pulse width signal is equal to one quarter of the first counting period; or/and
a time difference between rising edges of the fourth pulse width signal and the eighth pulse width signal is equal to one quarter of the second counting period, or/and a time difference between falling edges of the fourth pulse width signal and the eighth pulse width signal is equal to one quarter of the second counting period.
